(19) United States
(12) Patent Application Publication
(10) Pub. No.: US 2022/0197341 A1
(43) Pub. Date: Jun. 23, 2022

(54) Foldable Display Mobile Device with Object Motion Synching

(71) Applicant: Lepton Computing, LLC, Brooklyn, NY (US)

(72) Inventor: Stephen Delaporte, Brooklyn, NY (US)

(73) Assignee: Lepton Computing, LLC, Brooklyn, NY (US)

(21) Appl. No.: 17/521,847

(22) Filed: Nov. 8, 2021

Related U.S. Application Data
(60) Provisional application No. 63/111,047, filed on Nov. 8, 2020.

(51) Int. Cl. G06F 1/16

(52) U.S. Cl. CPC G06F 1/1652; G06F 1/1643; G06F 1/1616

(57) ABSTRACT

A foldable touch screen display device made up of flexible or tiled display segments that can be folded from a compact state to an expanded state which also includes an object motion synching system. The form factor of the compact state is roughly the size of a typical handheld phone or smaller. The form factor of the expanded state is roughly the size of a larger phone or tablet computer, which may also include the mechanical functionality of a laptop. The device form factor may also be a flip phone configuration. Both folded states may include an integrated speaker and microphone. The object motion synching system can automatically rotate one or both display segments using an actuator such that at least one display segment can remain in the same position independent of the movement of the other display segment. The device may further include sensors to indicate the required position of at least one of the display segments. In one embodiment, a module attached to, situated within, or otherwise associated with at least one segment of the flexible display or rigid display may contain all or substantially all processing and memory, along with a communications system, which may be used in any folded state.

### CROSS REFERENCE TO RELATED APPLICATIONS

This application claims the benefit of U.S. Provisional Patent Application No. 63/111,047, filed on Nov. 8, 2020, which is incorporated in its entirety herein by reference.

### FIELD OF THE INVENTION

The present invention relates generally to computing devices, and more particularly, to a computing device with a touch screen display that can be folded from a compact state to an expanded state.

### BACKGROUND OF THE INVENTION

The use of handheld computing devices today has been significantly enabled by a number of advancements in electronics, including the miniaturization of components, an increase in processing speeds, improved memory capacity, and the optimization of battery efficiency. Advancements in touch screen display technology have also enabled interfaces to become more adaptable and intuitive to use on a small scale. Because of these enormous improvements over the last decade, the differences in the performance between handheld computing devices, such as mobile phones, and larger computing devices, have become increasingly subtle.

One of the great difficulties in using a small-scale touch screen device, however, is in the fact that it can often be cumbersome to physically interact with. This is especially apparent when selecting and manipulating features and inputting text, which can sometimes be imprecise for a user. In such handheld computing devices as a touch screen mobile phone, the limited size of the display can also significantly reduce the viewing capacity while watching videos, using graphic intensive applications, and reading text. The rigid nature of a standard touch screen display can also limit the portability of a device when its form factor is in the larger size range for a phone, or at the scale of a tablet, which makes folding a desirable feature. Additionally, because a foldable device fundamentally has a hinge mechanism built in, when taking pictures or videos with the device, the hinge is not optimized to accommodate synching the motion and position of the device during these kinds of applications or others where the device may need to be constantly repositioned to provide synching with an object that is being photographed or filmed or when viewing of content needs to be repositioned to synch with the motion of someone viewing the device.

There is therefore a need for touch screen display devices that can be adjusted in size without sacrificing the convenience of being small and handheld. There is also a need for an object motion synching system that can automatically rotate one or both segments of the device such that a first device segment can move into any position along a defined axis in space, while a second device segment may be free to rotate independent of the first device segment or remain completely fixed such as through sitting on a table while the first segment automatically rotates into position.

### SUMMARY OF EMBODIMENTS OF THE INVENTION

A foldable touch screen display device made up of flexible or tiled display segments that can be folded from a compact state to an expanded state which also includes an object motion synching system. The form factor of the compact state is roughly the size of a typical handheld phone or smaller. The form factor of the expanded state is roughly the size of a larger phone or tablet computer, which may also include the mechanical functionality of a laptop. The device form factor may also be a flip phone configuration. Both folded states may include an integrated speaker and microphone. The object motion synching system can automatically rotate one or both display segments using an actuator such that at least one display segment can remain in the same position independent of the movement of the other display segment. The device may further include sensors to indicate the required position of at least one of the display segments. In one embodiment, a module attached to, situated within, or otherwise associated with at least one segment of the flexible display or rigid display may contain all or substantially all processing and memory, along with a communications system, which may be used in any folded state.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a perspective view of a foldable computing device shown in three separate positions where one segment is being rotated in the same motion sequence of a moving object or point of interest situated in front of its camera, while the other segment remains fixed along the same axis;

FIG. 2 is a perspective view of the foldable computing device shown in two separate positions enlarged from FIG. 1 to highlight the internal drive mechanism which is made up of an actuator and an encoder.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

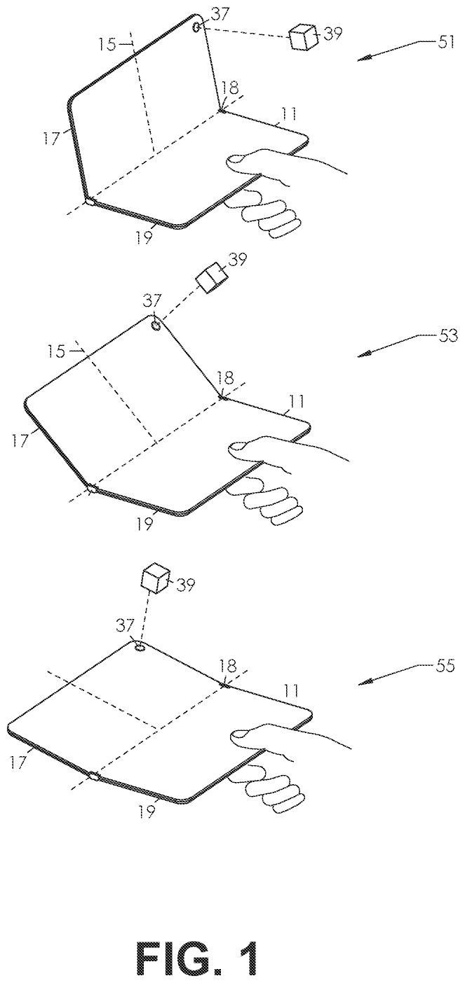

In accordance with the exemplary embodiment shown in FIG. 1, a foldable computing device 11 is illustrated where display segment 19 may either be held by the hand or may remain sitting on a ground plane such as a table so that it remains in a fixed position as shown in each position 81, 83, and 85. Display segment 17 and it's corresponding camera 37 are alternatively shown in three separate positions rotating about hinge 18 starting with position 81, where the edge of segment 17 is angled upward, and from there it is then automatically rotated into the second position 83, where segment 17 is repositioned to an approximately 45 degree angle, and from there it is then automatically rotated into the third position 85, where segment 17 is then repositioned so that it is parallel with the ground plane. The movement of the position of display segment 17, which is emphasized by the changing angle of the segment's center axis 15, is a result of the object motion synching system that is detected by camera 37 where the display segment 17 and its embedded camera 37 moves with the same movement that corresponds to the object it is programmed to track. In this particular case, the reference cube 39 represents the position of a point of interest detected by the camera. This could be an object that is automatically detected, or something that the device is programmed to recognize using computer vision, such as someone's face moving or the motion of someone's hand. The different positions shown in FIG. 1 also emphasizes how having the rotational motion range where various positions can be achieved for object motion synching by one segment while the other segment remains fixed, can give the user the ability to view content on the display while moving, such as if the user is walking and holding the device or performing a task that requires them to move around the device while utilizing apps such as a video conference feature. This rotational motion range can also be advantageous for taking pictures or videos if the user wants to have the flexibility to move into different positions while keeping one segment fixed where the other segment and its embedded camera is free to mimic the motion of the person moving.

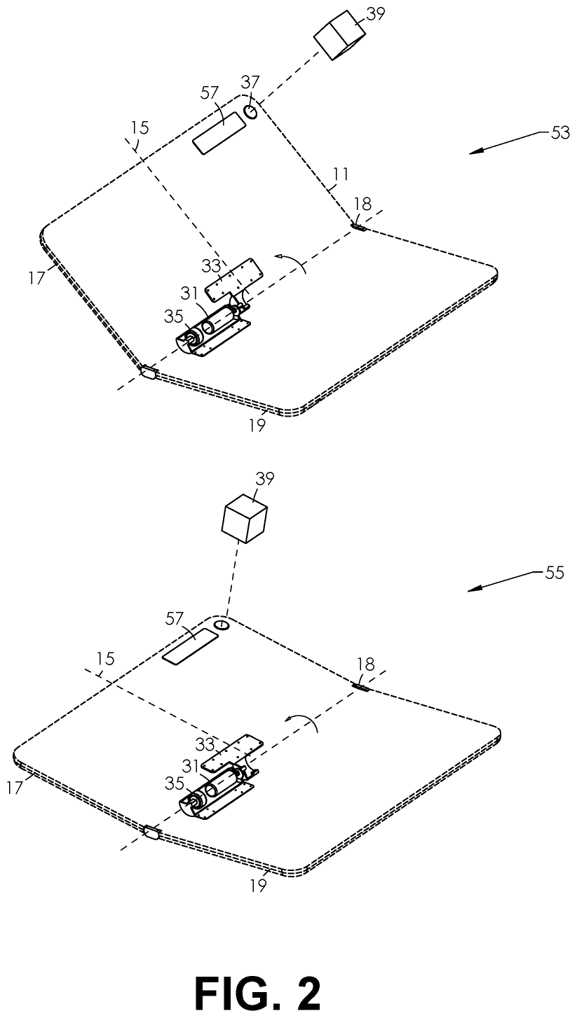

FIG. 2 is a perspective view of the foldable computing device shown in two separate positions 53 and 55 enlarged from FIG. 1 to highlight the internal motion synching drive mechanism which is made up of an actuator or motor 31 to drive the segments into the desired position from rotating about the center hinge 18, which is situated between each of the display segments 17 and 19, that also includes an encoder 35 to ensure that the position accuracy is correct, and a drive plate 33 that is coupled to at least one of the display segments, in this case segment 17. Sensor modules 57 can be included on one segment or both segments. Sensor module 57 may include an accelerometer to assist with determining the position and angle of each segment in space and relative to each other. Other sensors that might be included to enhance object tracking are IR sensors, Sonar Sensors, and LiDAR sensors. The encoder 35 can also help in determining the exact position of each segment relative to each other along with data taken in real time from the accelerometers. It is also important to consider that the whole object motion synching drive mechanisms could be produced as a standalone device that gets attached to the back side of the foldable mobile device with the sensor also attached to the device to provide the same functionality. This motion synching system could also be used to actuate motion through the hinge mechanism such that the display segment corresponds to motions with the segment's displayed content, such as the motion of a face displayed looking up or down so that the display segment rotates to mimic the same motion shown on the display. This featured could be toggled between synching with the motion that's displayed on the device's screen, and synching with a physical object that can be detected and tracked by the device's camera.

What is claimed is:

1. An apparatus comprising:
(a) a flexible touch-sensitive display composed of a first flexible touch-sensitive display portion and a second flexible touch-sensitive display portion; wherein:
(1) the first flexible touch-sensitive display portion is attached to a first structural support segment;
(2) the second flexible touch-sensitive display portion is attached to a second structural support segment;
(3) the flexible touch-sensitive display further comprises having a fully folded state;
(4) the flexible touch-sensitive display further comprises having a partially expanded state;
(5) the flexible touch-sensitive display further comprises having a fully expanded state;
(b) an object motion synching system configured to automatically rotate at least one flexible touch-sensitive display structural support segment using an actuator such that at least one flexible touch-sensitive display structural support segment can move in conjunction with an object that the camera of the apparatus is tracking.

2. The apparatus of claim 1 wherein:
the object motion synching system includes an encoder coupled to the actuator for accurate position feedback.

3. The apparatus of claim 1 wherein:
the object motion synching system includes at least one accelerometer to detect the position of the flexible touch-sensitive display structural support segments relative to each other and the ground plane.

4. The apparatus of claim 1 wherein:
the object motion synching system actuates the angle of at least one flexible touchsensitive display structural support segment based upon the position of an object shown on the flexible touch-sensitive display.

5. The apparatus of claim 1 wherein:
the object motion synching system actuates the angle of at least one flexible touchsensitive display structural support segment based upon the position of an object shown on the flexible touch-sensitive display which is captured the camera of the apparatus.

6. The apparatus of claim 1 wherein:
the fully folded state comprises a fully folded angle between the first flexible touchsensitive display component and the second flexible touch-sensitive display component that is less than 10 degrees; and
the fully expanded state comprises a fully expanded angle between the first flexible touch-sensitive display component and the second flexible touch-sensitive display component that is between 170 and 190 degrees; and
the partially expanded state comprises an angle that falls between the fully folded state and the fully expanded state.

7. An apparatus comprising:
(a) a rigid touch-sensitive display;
(b) a flexible touch-sensitive display composed of a first flexible touch-sensitive display portion and a second flexible touch-sensitive display portion; wherein:
(1) the first flexible touch-sensitive display portion is attached to a first structural support segment;
(2) the second flexible touch-sensitive display portion is attached to a second structural support segment;
(3) the flexible touch-sensitive display further comprises having a fully folded state;
(4) the flexible touch-sensitive display further comprises having a partially expanded state;
(5) the flexible touch-sensitive display further comprises having a fully expanded state;
(b) an object motion synching system configured to automatically rotate at least one flexible touch-sensitive display structural support segment using an actuator such that at least one flexible touch-sensitive display structural support segment can move in conjunction with an object that the camera of the apparatus is tracking.

8. The apparatus of claim 8 wherein:
the object motion synching system includes an encoder coupled to the actuator for accurate position feedback.

9. The apparatus of claim 8 wherein:
the object motion synching system includes at least one accelerometer to detect the position of the flexible touch-sensitive display structural support segments relative to each other and the ground plane.

10. The apparatus of claim 8 wherein:
the object motion synching system actuates the angle of at least one flexible touchsensitive display structural support segment based upon the position of an object shown on the flexible touch-sensitive display.

11. The apparatus of claim 8 wherein:
the object motion synching system actuates the angle of at least one flexible touchsensitive display structural support segment based upon the position of an object shown on the flexible touch-sensitive display which is captured the camera of the apparatus.

12. The apparatus of claim 8 wherein:
the fully folded state comprises a fully folded angle between the first flexible touchsensitive display component and the second flexible touch-sensitive display component that is less than 10 degrees; and
the fully expanded state comprises a fully expanded angle between the first flexible touch-sensitive display component and the second flexible touch-sensitive display component that is between 170 and 190 degrees; and
the partially expanded state comprises an angle that falls between the fully folded state and the fully expanded state.

13. An apparatus comprising:
(a) a first touch-sensitive display and a second touch-sensitive display; wherein:
(1) the first touch-sensitive display is attached to a first structural support segment;
(2) the second touch-sensitive display is attached to a second structural support segment;
(3) the touch-sensitive displays further comprise having a fully folded state;
(4) the touch-sensitive displays further comprise having a partially expanded state;
(5) the touch-sensitive displays further comprise having a fully expanded state;
(b) an object motion synching system configured to automatically rotate at least one touch-sensitive display structural support segment using an actuator such that at least one touchsensitive display structural support segment can move in conjunction with an object that the camera of the apparatus is tracking.

14. The apparatus of claim 13 wherein:
the object motion synching system includes an encoder coupled to the actuator for accurate position feedback.

15. The apparatus of claim 13 wherein:
the object motion synching system includes at least one accelerometer to detect the position of the touch-sensitive display structural support segments relative to each other and the ground plane.

16. The apparatus of claim 13 wherein:
the object motion synching system actuates the angle of at least one touch-sensitive display structural support segment based upon the position of an object shown on the touchsensitive display.

17. The apparatus of claim 13 wherein:
the object motion synching system actuates the angle of at least one touch-sensitive display structural support segment based upon the position of an object shown on the touchsensitive display which is captured the camera of the apparatus.

18. The apparatus of claim 13 wherein:
the fully folded state comprises a fully folded angle between the first touch-sensitive display component and the second touch-sensitive display component that is less than 10 degrees; and
the fully expanded state comprises a fully expanded angle between the first touchsensitive display component and the second touch-sensitive display component that is between 170 and 190 degrees; and
the partially expanded state comprises an angle that falls between the fully folded state and the fully expanded state.
